(19) United States
(12) Patent Application Publication
(10) Pub. No.: US 2024/0357713 A1
(43) Pub. Date: Oct. 24, 2024

(54) FURNACE INCLUDING HEATING ZONES WITH ELECTRICALLY POWERED HEATING ELEMENTS AND RELATED METHODS

(71) Applicant: SABIC GLOBAL TECHNOLOGIES B.V., BERGEN OP ZOOM (NL)

(72) Inventors: Scott A. STEVENSON, Houston, TX (US); Andrew Mark WARD, Redcar (GB); Michael Edward HUCKMAN, Houston, TX (US); Hongbing JIAN, Houston, TX (US); Arno Johannes Maria OPRINS, Geleen (NL); Thomas DIJKMANS, Geleen (NL); Lei CHEN, Houston, TX (US); Joseph William SCHROER, Houston, TX (US); Robert BROEKHUIS, Houston, TX (US)

(73) Assignee: SABIC GLOBAL TECHNOLOGIES B.V., BERGEN OP ZOOM (NL)

(21) Appl. No.: 18/682,762

(22) PCT Filed: Aug. 8, 2022
(86) PCT No.: PCT/EP2022/072198

§ 371 Date: Feb. 9, 2024

(30) Foreign Application Priority Data
Aug. 12, 2021 (EP) 21191028.6

(51) Int. Cl. H05B 3/66; H05B 1/02

(52) U.S. Cl. CPC H05B 3/66; H05B 1/0291; H05B 2203/007

(57) ABSTRACT

An electrically powered furnace and related methods may include an electrically powered furnace having an output of at least one megawatt with a control system; a furnace housing comprising one or more housing walls at least partially defining an interior volume; a plurality of heating zones within the interior volume; and a plurality of heated tubes extending in the interior volume. A method may include providing the feed to the electrically powered furnace; and algorithmically adjusting the output of the one or more heating elements for each of the plurality of heating zones to heat the feed to a desired temperature while maintaining temperatures of the one or more heating elements within predetermined parameters.

### TECHNICAL FIELD

The present disclosure relates to furnaces including heating zones having electrically powered heating elements and related methods and, more particularly, to furnaces for heating a feed and including heating zones having electrically powered heating elements and related methods.

### BACKGROUND

Some furnaces for heating a material may include two opposing walls and one or more columns of tubes positioned between the two opposing walls and through which the material may pass during heating of the material. Each of the two opposing walls may provide a heat input to the tubes, and as the material to be heated passes through the tubes, heat is transferred from the tubes to the material. It has been recognized that it may be environmentally advantageous to configure such furnaces to provide the heat input to the tubes using electrically powered heating elements.

Because material being heated enters the inlet of the tubes at a relatively lower temperature than the heated material exiting the outlet of the tubes, the temperature of the tubes, and the heating elements may typically vary from a relatively lower temperature near the inlet of the tubes to a relatively higher temperature near the outlet of the tubes. As a result, the tubes may not uniformly heat the material as it passes through the tubes, and the temperatures among heating elements may likewise not be uniform. In some processes, this may limit the efficiency of the furnace and cause problems resulting from uneven heating of the material. For example, the temperature of the tubes at the inlet may be lower than optimal, while the temperature at the outlet may be higher than optimal. This may lead to premature material fouling (e.g., coking) of the tubes at the outlet due to the material reaching a higher than optimal temperature, and in some processes, the temperature at the outlet of the tubes may reach temperatures resulting in premature damage to the tubes. Thus, if the tubes are heated uniformly, increasing the temperature at the inlet of the tubes to obtain optimal material heating at the inlet may result in the outlet of the tubes becoming too hot. Conversely, if less heat is input to the tubes to prevent the outlet of the tubes from becoming too hot, the inlet of the tubes may be too cool to optimize heating of the material as the material enters the tubes. In another example, the temperature of the heating elements near the outlet may be higher than the temperature of the heating elements near the inlet, which may result in higher maintenance cost for the furnace.

An attempt to provide an improved electrically heated furnace for performing gas conversion processes at an industrial scale is described in PCT International Publication No. WO 2020/002326 A1 to Shell Internationale Research Maatschappij B.V. (“the '326 publication”). The '326 publication describes a reactor configuration including an electrically heated furnace and a reactor tube placed within the furnace. The furnace of the '326 publication also includes an electrical radiative heating element suitable for heating to high temperatures in the range of 400 to 1400° C. According to the '326 publication, in many applications, the heat-flux is larger when the process gas enters the furnace while having a lower temperature, and toward the exit the heat-flux is lower while having a higher temperature. The '326 publication purports to describe a furnace that accommodates these process parameters.

Applicant has recognized that the furnace and process of '326 publication may still result in a need for systems and methods for producing products that are more efficient or more environmentally friendly, and/or provide advantages in operating or maintenance costs. Thus, although the furnace and process described in the '326 publication purport to provide gains in efficiency, there still is a need for systems and methods for producing heated products that are more efficient and/or more environmentally friendly.

Accordingly, Applicant has recognized a need for furnaces and related methods for providing heat to heated tubes via electrically powered heating elements that provides more efficient heating and/or reduces temperature differentials among (parts of) heated tubes and among (parts of) heating elements that provide the outlet of the heated tubes. The present disclosure may address one or more of the above-referenced drawbacks, as well as other possible drawbacks.

### SUMMARY

As referenced above, some furnaces may not provide sufficiently uniform heating along the length of tubes used to heat a material passing through the tubes, thereby lacking efficiency and potentially overheating the material being heated and/or the outlet ends of the tubes. Likewise, they may not provide sufficiently uniform temperatures among heating elements. The present disclosure is generally directed to electrically powered furnaces and related methods and, more particularly, to furnaces for heating a feed and including heating zones having one or more electrically powered heating elements and related methods.

For example, in some embodiments, a method of heating a feed may include providing an electrically powered furnace having an output of at least one megawatt. The electrically powered furnace may include a control system and a furnace housing including one or more housing walls at least partially defining an interior volume. The electrically powered furnace may also include a plurality of heating zones within the interior volume, each of the plurality of heating zones including one or more heating elements being electrically powered and radiating heat from their surfaces when activated. Each of the plurality of heating zones may respond independently to the control system. The control system may vary an output of the one or more heating elements in each zone as a fraction of a maximum output of each of the one or more heating elements. The electrically powered furnace may also include a plurality of heated tubes extending in the interior volume, each of the plurality of heated tubes extending between an inlet end and an outlet end and defining an interior passage positioned to receive the feed and heat the feed as the feed passes through the interior passage from the inlet end to the outlet end, and the plurality of heated tubes being positioned in the furnace housing to receive heat radiated from the one or more heating elements in each of the plurality of heating zones. The method may also include providing the feed to the electrically powered furnace; and algorithmically adjusting the output of the one or more heating elements for each of the plurality of heating zones to heat the feed to a desired temperature while maintaining temperatures of the one or more heating elements within predetermined parameters.

In certain embodiments, the temperatures of the one or more heating elements may be instrumentally measured during operation, and the measured temperatures may be used in algorithmically adjusting the output of the one or more heating elements for each of the plurality of heating zones. In certain embodiments, the temperatures of the one or more heating elements may be calculated from a prediction model, and the calculated temperatures may be used in algorithmically adjusting the output of the one or more heating elements for each of the plurality of heating zones.

In certain embodiments, algorithmically adjusting the output of the one or more heating elements may include minimizing a highest temperature among combined heating element surfaces. The control system may utilize a ratio of outputs from each of the plurality of heating zones to maintain an even temperature distribution across the one or more heating elements while maintaining process performance. The predetermined parameters may be uniformity of temperature, wherein the maximum temperature difference between the highest temperature on any of each individual heating element surface and the lowest temperature on any heating element surface may be smaller than 100 degrees Celsius, preferably less than 60, more preferably less than 30, during standard operations of the furnace. The predetermined parameters may be uniformity of temperature, wherein the maximum difference between the highest temperature on any heating element surface and the lowest temperature on any heating element surface may be smaller than 100 degrees Celsius, preferably less than 60, more preferably less than 30, during standard operation of the furnace.

The control system may determine a relative power output to each of the plurality of heating zones. One or more heating zones near the inlet end of the plurality of heating tubes may have a higher output than one or more heating zones near the outlet end of the plurality of heating tubes. The output of the lowest output heating zone may be at least 10% below the output of a highest output heating zone. The electrically powered furnace may also include a thermal partition between a) a first subset of the plurality of heating zones and a first portion of the plurality of heated tubes, and b) a second subset of the plurality of heating zones and a second portion of the plurality of heated tubes, wherein the thermal partition at least partially thermally insulates the first subset and first portion from the second subset and second portion.

In certain embodiments, a number of heating zones may be greater than two. One or more heating elements may be electrically resistive elements attached or adjacent to a housing wall. The furnace housing may also include a conductive refractory that radiates heat to the plurality of heated tubes when activated.

In some embodiments, an electrically powered furnace may include a plurality of heating zones, with each of the heating zones including one or more heating elements being electrically powered and configured to radiate heat. The furnace also may include a plurality of heated tubes extending between an inlet end and an outlet end and configured to receive the feed and heat the feed as the feed passes from the inlet end to the outlet end. The plurality of heating zones may include heating zones configured to radiate different heat inputs to the heated tubes, such that heat input at the inlet end of the heated tubes is greater than the heat input at the outlet end of the heated tubes. At least some embodiments of the furnaces and methods disclosed herein may result in electrically powered furnaces that provide more uniformly heated tubes, more uniformly heated feed material, more uniform temperatures of the heating elements, and/or more efficient heating. In some embodiments, an electrically powered furnace may have a power output of 1 megawatt (MW) or greater

According some embodiments, an electrically powered furnace to heat a feed may include a furnace housing including one or more housing walls at least partially defining an interior volume. The electrically powered furnace also may include a plurality of heating zones, each of the plurality of heating zones including one or more heating elements being electrically powered and configured to radiate heat. The electrically powered furnace further may include a plurality of heated tubes extending in the interior volume. Each of the plurality of heated tubes may extend between an inlet end and an outlet end and define an interior passage positioned to receive the feed and heat the feed as the feed passes through the interior passage from the inlet end to the outlet end. The plurality of heated tubes may be positioned in the furnace housing to receive heat radiated from the one or more heating elements. The plurality of heating zones may include a first heating zone including at least one of the one or more heating elements and configured to radiate a first heat input to a first length portion of the plurality of heated tubes associated with the inlet end. The plurality of heating zones also may include a second heating zone including at least one of the one or more heating elements and configured to radiate a second heat input to a second length portion of the plurality of heated tubes associated with the outlet end. The first heat input may be greater than an average heat input of the first heat input and the second heat input, and the second heat input may be less than the average heat input.

According to some embodiments, a hydrocarbon heating assembly may include an electrically powered furnace, and the electrically powered furnace may be one of a steam cracking furnace, a steam methane reformer, or a hydrocarbon heater for dehydrogenation. The electrically powered furnace may include one or more housing walls at least partially defining an interior volume. The electrically powered furnace also may include a plurality of heating zones, each of the plurality of heating zones including at least one heating element being electrically powered and configured to radiate heat. The electrically powered furnace further may include a plurality of heated tubes extending in the interior volume. Each of the plurality of heated tubes may extend between an inlet end and an outlet end and define an interior passage positioned to receive the feed and heat the feed as the feed passes through the interior passage from the inlet end to the outlet end. The plurality of heated tubes may be positioned in the furnace housing to receive heat radiated from at least one of the one or more heating elements. The plurality of heating zones may include a first heating zone including at least one of the one or more heating elements and configured to radiate a first heat input to a first length portion of the plurality of heated tubes associated with the inlet end. The plurality of heating zones also may include a second heating zone including at least one of the one or more heating elements and configured to radiate a second heat input to a second length portion of the plurality of heated tubes associated with the outlet end. The first heat input may be greater than an average heat input of the first heat input and the second heat input, and the second heat input may be less than the average heat input.

According to some embodiments, a method to provide heat to a feed may include supplying a feed to a plurality of heated tubes each extending from an inlet end to an outlet end and defining interior passage. The method also may include heating each of the plurality of heated tubes via a first heating element configured to radiate a first heat input to a first length portion of the plurality of heated tubes associated with the inlet end. The method further may include heating each of the plurality of heated tubes via a second heating element configured to radiate a second heat input to a second length portion of the plurality of heated tubes associated with the outlet end, with the first heat input being greater than an average of the first heat input and the second heat input, and the second heat input being less than the average heat input. The method still further may include heating the feed via the plurality of heated tubes as the feed passes through the interior passage of each of the heated tubes from the inlet end to the outlet end.

Still other aspects and advantages of these exemplary embodiments and other embodiments, are discussed in detail herein. Moreover, it is to be understood that both the foregoing information and the following detailed description provide merely illustrative examples of various aspects and embodiments, and are intended to provide an overview or framework for understanding the nature and character of the claimed aspects and embodiments. Accordingly, these and other objects, along with advantages and features of the present disclosure, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain principles of the embodiments discussed herein. No attempt is made to show structural details of this disclosure in more detail than can be necessary for a fundamental understanding of the embodiments discussed herein and the various ways in which they can be practiced. According to common practice, the various features of the drawings discussed below are not necessarily drawn to scale. Dimensions of various features and elements in the drawings can be expanded or reduced to more clearly illustrate embodiments of the disclosure.

FIG. 1 schematically illustrates a side view of an example heating assembly according to embodiments of the disclosure.

FIG. 2A schematically illustrates a top view of an example electrically powered furnace according to embodiments of the disclosure.

FIG. 2B schematically illustrates a side view of the example electrically powered furnace shown in FIG. 2A according to embodiments of the disclosure.

FIG. 3 is a graph showing heat input as a function of heated tube position for an electrically powered furnace consistent with the example electrically powered furnace shown in FIGS. 2A and 2B, according to embodiments of the disclosure.

FIG. 4 schematically illustrates a side view of another example heating assembly according to embodiments of the disclosure.

FIG. 5A is a graph of the temperature of an outer diameter surface of an example heated tube as a function of position along the length of the heated tube for a furnace having a single heating zone with a constant heat flux across the length of the furnace wall.

FIG. 5B is a graph of the temperature of an outer diameter surface of an example heated tube as a function of position along the length of the heated tube for an example electrically powered furnace having three heating zones, according to embodiments of the disclosure.

FIG. 5C is a graph of the temperature of an outer diameter surface of an example heated tube as a function of position along the length of the heated tube for an example electrically powered furnace having six heating zones according, to embodiments of the disclosure.

FIG. 6A illustrates a model representative of a furnace wall temperature field for a furnace having a single heating zone with a constant heat flux across the length of the furnace wall.

FIG. 6B illustrates a model representative of a furnace wall temperature field for an example furnace having six heating zones distributed across the furnace wall, according to embodiments of the disclosure.

FIG. 7 is a block diagram of an example method to heat a feed by passing the feed through one or more heated tubes of an electrically powered furnace according to embodiments of the disclosure.

### DETAILED DESCRIPTION

The drawings may use like numerals to indicate like parts throughout the several views, the following description is provided as an enabling teaching of exemplary embodiments, and those skilled in the relevant art will recognize that many changes may be made to the embodiments described. It also will be apparent that some of the desired benefits of the embodiments described can be obtained by selecting some of the features of the embodiments without utilizing other features. Accordingly, those skilled in the art will recognize that many modifications and adaptations to the embodiments described are possible and may even be desirable in certain circumstances. Thus, the following description is provided as illustrative of the principles of the embodiments and not in limitation thereof.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to,” unless otherwise stated. Thus, the use of such terms is meant to encompass the items listed thereafter, and equivalents thereof, as well as additional items. The transitional phrases “consisting of” and “consisting essentially of,” are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish claim elements.

In certain embodiments, a method of heating a feed may include providing an electrically powered furnace having an output of at least one megawatt. The electrically powered furnace may include a control system and a furnace housing with one or more housing walls at least partially defining an interior volume. A plurality of heating zones may be within the interior volume, each of the plurality of heating zones including one or more heating elements being electrically powered and radiating heat from their surfaces when activated. Each of the plurality of heating zones may respond independently to the control system. The control system may vary an output of the one or more heating elements in each zone as a fraction of a maximum output of each of the one or more heating elements. A plurality of heated tubes may extend in the interior volume where each of the plurality of heated tubes may extend between an inlet end and an outlet end and may define an interior passage positioned to receive the feed and heat the feed as the feed passes through the interior passage from the inlet end to the outlet end. The plurality of heated tubes may be positioned in the furnace housing to receive heat radiated from the one or more heating elements in each of the plurality of heating zones.

In certain embodiments, the method may also include providing the feed to the electrically powered furnace; and algorithmically adjusting the output of the one or more heating elements for each of the plurality of heating zones to heat the feed to a desired temperature while maintaining temperatures of the one or more heating elements within predetermined parameters.

In certain embodiments, temperatures of the one or more heating elements may be instrumentally measured during operation. In certain embodiments, temperatures of the one or more heating elements may be calculated using a prediction model. The instrumentally measured or calculated temperatures may be used in algorithmically adjusting the output of the one or more heating elements for each of the plurality of heating zones.

Algorithmically adjusting the output of the one or more heating elements may include minimizing a highest temperature among combined heating element surfaces. It may further include control strategies based on feedback control, control strategies based on feed-forward control, or combinations thereof.

The predetermined parameters within which temperatures of the one or more heating elements are maintained may include uniformity of temperature, wherein the maximum difference between the highest temperature on any heating element surface and the lowest temperature on any heating element surface is smaller than 100 degrees Celsius, preferably less than 60, more preferably less than 30, during standard operation of the furnace. Standard operation of the furnace pertains to the time during which the furnace operation maintains a desired production by heating the feed to a desired temperature. It is generally desired to maintain more or less steady state conditions during such operation, but standard operation may include adjustments necessary to maintain operation in the face of changing conditions such as feed rate and equipment condition. Standard operation does not include startup or shutdown operation, or non-productive operation (for example, decoking operation in the case of steam cracking).

In certain embodiments, the control system may determine a relative power output to each of the plurality of heating zones.

In certain embodiments, the control system may utilize a ratio of outputs from each of the plurality of heating zones to maintain an even temperature distribution across the one or more heating elements while maintaining process performance. Maintaining process performance may mean maintaining the feed exit temperature at or near a desired value, or maintaining the level of conversion of one or more chemical reactions occurring inside the heated tubes at desired values.

In certain embodiments, one or more heating zones near the inlet end of the plurality of heating tubes may have a higher output than one or more heating zones near the outlet end of the plurality of heating tubes. The output of a lowest output heating zone may be at least 10% below, or at least 20% below, or at least 30% below the output of a highest output heating zone. The output of a heating zone may mean the wall heat load, i.e., the heat developed by the heating elements within the heating zone (for example, in kW) divided by the wall surface area occupied by these heating elements (for example, in m²).

The electrically powered furnace may also include a thermal partition between a) a first subset of the plurality of heating zones and a first portion of the plurality of heated tubes, and b) a second subset of the plurality of heating zones and a second portion of the plurality of heated tubes, wherein the thermal partition at least partially thermally insulates the first subset and first portion from the second subset and second portion.

The number of heating zones in various embodiments may be greater than two, greater than three, greater than four, greater than five, greater than six, greater than seven, greater than eight, greater than nine, greater than ten, greater than eleven, greater than twelve, etc.

The one or more heating elements may be electrically resistive elements attached or adjacent to a housing wall. The housing wall may be clad in or consist of thermally refractory materials, such as brick or fibrous ceramic insulation.

The furnace housing may also include a conductive refractory that radiates heat to the plurality of heated tubes when activated. The use of conductive refractory materials, such as refractory bricks, may provide an alternative to metal wire or metal ribbon heating elements, and may eliminate or reduce certain design constraints of those systems. The conductive refractory materials may be bricks with no metal conducts where instead current flows through the conductive refractory materials. In certain embodiments, the conductive refractory material may be ceramic. The conductive refractory materials may be arranged within the furnace such that they define one of more of the heating zones. In such embodiments, a conductive refractory brick, or other such unit of construction, may be considered a heating element.

The invention also pertains to an apparatus operating the feed heating method described above.

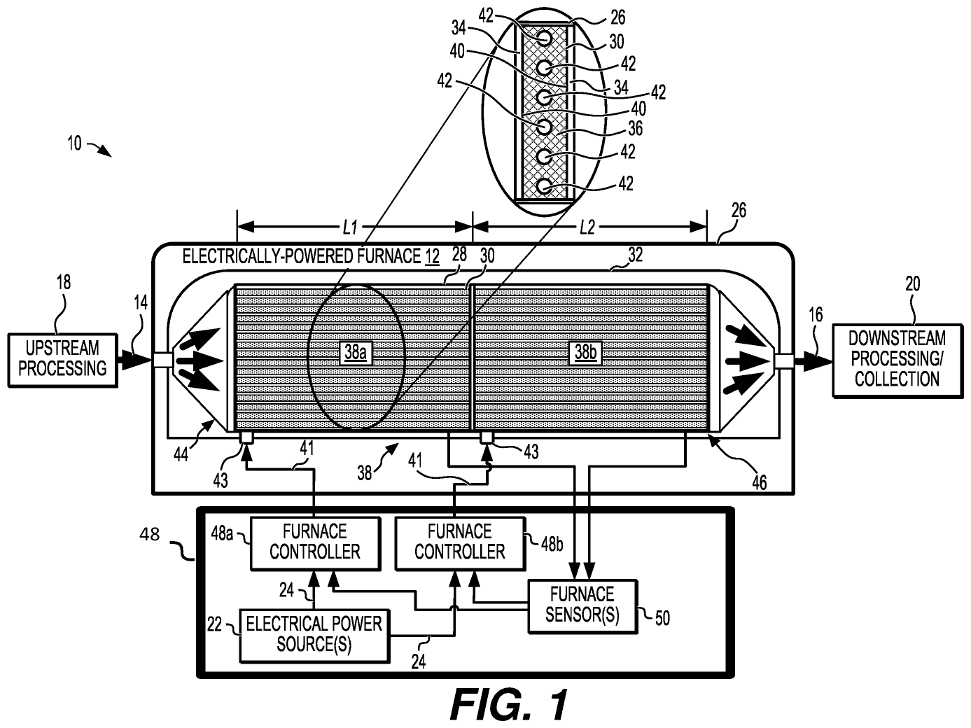

FIG. 1 shows an example heating assembly 10 according to embodiments of the disclosure. As shown in FIG. 1, the heating assembly 10 may include an electrically powered furnace 12 for receiving a feed 14, which may include any material or materials that are heated during a heating process, and the electrically powered furnace 12 may heat the feed 14 to provide heated products 16, which may include precursors, intermediate products, and/or final products. In some embodiments, the electrically powered furnace 12 may be, or include, any electrically powered heater or heating device for heating a solid, fluid, gas, and/or combination thereof from a first temperature to a second temperature greater than the first temperature. In some embodiments, the electrically powered furnace 12 may have a power output of 1 megawatt (MW) or greater, for example, 2 MW, 3 MW, 5 MW, 10 MW, 15 MW, 20 MW, 30 MW, 40 MW, 50 MW, 100 MW, 200 MW, or 1 GW. In some embodiments, the electrically powered furnace 12 may be configured to convert electricity into heat sufficient to supply the energy needed for endothermic reactions, for example, for supplying the heat of reaction. For example, the feed 14 may include hydrocarbons, and the heating assembly 10 may be a hydrocarbon heating assembly, such as, for example, an electrically powered cracking furnace to produce petroleum-derived products, which may include precursors, intermediate products, and/or final products, a steam methane reformer, a hydrocarbon heater for dehydrogenation, or any other process heating need, for example, any application or process that is capable of accepting heat provided by electrical heating elements. Other types of heating assemblies for heating other types of materials are contemplated.

In some embodiments, the heating assembly 10 shown in FIG. 1 may include upstream processing 18 for the feed 14 prior to the feed 14 reaching the electrically powered furnace 12. For example, for heating assemblies 10 used to crack hydrocarbons, the upstream processing 18 may include, for example, a pre-heating section into which a hydrocarbon feed stream and a dilution stream may be supplied into pre-heating tubes for combining and pre-heating the hydrocarbon feed stream and the dilution stream, for example, as will be understood by those skilled in the art. For example, a hydrocarbon feed stream may include naphtha, ethane, and/or other hydrocarbons, and the electrically powered furnace 12 may at least partially crack the hydrocarbon feed stream to provide cracked hydrocarbons, which may include olefins, methane, and other by-products of the cracking process, as will be understood by those skilled in the art. Other types of upstream processes are contemplated.

As shown in FIG. 1, some embodiments of the heating assembly 10 may also include downstream processing/collection 20 for receiving the heated products 16, once the materials of the feed 14 have been heated in the electrically powered furnace 12 to provide the heated products 16. In some embodiments, the downstream processing/collection 20 may include additional reaction, processing, and/or treatment of the heated products 16.

As shown in FIG. 1, in some embodiments, the electrically powered furnace 12 may be supplied with electrical power from the one or more electrical power source(s) 22 via an electric power line 24. The electrical power source(s) 22 may include power generated independently from the heating assembly 10.

As shown in FIG. 1, the electrically powered furnace 12 may include a furnace housing 26 containing therein an electrically powered furnace section 28. The electrically powered furnace section 28 may include a heated tube section 30, through which the material feed 14 may flow during heating to output the heated products 16. As shown in FIG. 1, in some embodiments, the furnace section 28 may include a section housing 32 containing therein the heated tube section 30.

In some embodiments, as shown in FIG. 1, the furnace housing 26 may include pair of opposing housing walls 34 at least partially defining an interior volume 36 of the furnace housing 26. The electrically powered furnace 12 also may include a plurality of heating zones 38. Each of the plurality of heating zones 38 may include one or more heating elements 40 being electrically powered and configured to radiate heat. In some embodiments, the one or more heating elements 40 may be supplied with electrical power via one or more power lines 41 via one or more terminals 43. The electrical power supplied to the electrically powered furnace 12 may be alternating current (AC) or direct current (DC). In some embodiments, the heating zones 38 may be defined horizontally, for example, along the length of an electrically powered furnace 12 having one or more heating elements 40 extending horizontally (or vertically) with the length of the electrically powered furnace 12. In some embodiments, the heating zones 38 may be defined vertically, for example, up the height of an electrically powered furnace 12 having one or more heating elements 40 extending vertically (or horizontally) with the height of the electrically powered furnace 12. In some embodiments, the heating zones 38 may be defined in any combination of horizontally and vertically relative to an electrically powered furnace 12 having heating elements 40 extending in any combination of horizontally and vertically. In some embodiments, one or more of the heating zones 38 may be the same length. In some embodiments, one or more of the heating zones 38 may have different lengths. As used herein, heat input may refer to, for example, heat per unit surface area of a wall, surface, and/or barrier, which may be expressed for example, in units of power/unit area (e.g., kilowatts/square meter). In some embodiments, one or more of the heating zones 38 and/or one or more of the heating elements 40 may extend vertically, horizontally, or a combination of vertically and horizontally.

In some embodiments, the heating elements may be metallic heating elements comprising metallic alloys suitable for heating operations at the temperatures achieved in the furnace housing. Examples of such alloys include alloys including of iron, nickel, chromium, and/or aluminum. In some embodiments, the heating elements may include alloys of iron, chromium, and aluminum, which are sometimes referred to as FeCrAl. Such alloys are known to be suitable for operation at temperatures up to and even above 1300° C. According to investigation into the long-term performance of such alloys, their operational longevity may be due to the formation of a protective layer comprising alumina, allowing for months or years of operation before replacement is required. Even so, these alloys have a finite life in service, and according to scientific investigation, the useful life of elements comprising such alloys varies with temperature, the life generally decreasing as the temperature increases as oxidative degradation processes proceed more rapidly at high temperature. Maintenance schedules regarding replacement of heating elements in furnaces may be determined by the heating element that undergoes the most rapid degradation, which may be the heating element having the highest temperature. It is therefore desirable to maintain the temperature of the hottest portion of all heating elements in a furnace as low as possible. To minimize the hottest temperature while maintaining the desired feed exit temperature, it is desirable to maintain a high uniformity of temperature among all surfaces of heating elements. It is therefore desirable to maintain an even temperature distribution, by which is meant a distribution in which the difference between the highest and the lowest temperature among the heating element surfaces is lower than it would be if the output from each of the heating zones were the same. In some embodiments, the heating elements may be ceramic heating elements, such as heating elements comprising silicon carbide or molybdenum disilicide. Ceramic heating elements may have a similar relationship between operating temperature and useful service life as described for metallic heating elements. In some embodiments, metallic or ceramic heating elements may be conventionally formed heating elements, for example having the shape of a rod or strip attached to and extending or meandering along a wall of the furnace. In some embodiments, ceramic heating elements may be self-supporting structures, such as bricks, which may be combined (for example, stacked) to form walls or parts of walls.

Heating zones may include one or more heating elements. Each heating zone may provide, through its associated furnace controllers, a single output to its one or more heating elements; it is convenient to consider this output as a fraction of the maximum possible output that can be delivered to the one or more heating elements. For example, if the furnace is designed conservatively, with an overdesign factor of 125%, it may be possible to achieve the desired feed exit temperature when all heating zones are operated at an output of 80%. Even though the fractional output to each of the elements will be the same in this case, the temperatures of the individual heating elements within heating zones and among heating zones will generally not be uniform, due at least in part to the different temperatures of heating tubes in the vicinity of different heating elements. Not only may there be temperature differences among different heating elements, but different parts of the surface of a single heating element may also reach different temperatures. The temperature distribution resulting from any particular combination of heating element arrangement, heating tube arrangement, feed flowrate and temperature, and other variables may be assessed instrumentally, for example using temperature measurement by means of thermocouples, infrared cameras, or other suitable devices, or it may be predicted or estimated using predictive models. In evaluating and minimizing the highest temperature among heating elements, it is therefore desired to determine the highest temperature among the combined heating element surfaces (that is, the highest surface temperature of any portion of a heating element in the furnace), which may be higher than the average temperature of any single heating element.

As shown in FIG. 1, the electrically powered furnace 12 further may include a plurality of heated tubes 42 extending in the interior volume 36 of the furnace housing 26. In general, the embodiments described herein may be applied to heated tubes 42 of any geometry. In some embodiments, one or more of the heating heated tubes 42 may extend vertically, horizontally, or a combination of vertically and horizontally. In some embodiments, the heated tubes 42 may make a single pass through the electrically powered furnace 12 or more than one pass through the electrically powered furnace12. Each of the heated tubes 42 may include an inlet end 44 and an outlet end 46 and may define an interior passage extending between the inlet end 44 and the outlet end 46. In some embodiments, tubes may have multiple inlets and/or multiple outlets, where the number of inlets may be greater than, less than, or the same as the number of outlets. In some embodiments, the interior passage and/or an exterior surface of one or more of the heated tubes 42 may have a cross-sectional area and/or a cross-sectional shape that is the same as the cross-sectional shape and/or the cross-sectional area of one or more others of the heated tubes 42. In some embodiments, the interior passage and/or the exterior surface of one or more of the heated tubes 42 may have a cross-sectional area and/or a cross-sectional shape that differs from the cross-sectional shape and/or the cross-sectional area of one or more others of the heated tubes 42. The heated tubes 42 are not limited to cylindrical-shaped tubes and/or cylindrical-shaped interior passages. The cross-sectional shape of the interior passage and/or the exterior surface may be circular, elliptical, oval-shaped, oblong, polygonal, a combination of curved- and polygonal-shaped, or any cross-sectional shape suitable for a conduit. The interior passage may be configured to receive the feed 14 and heat the feed 14 as the feed 14 passes through the interior passage from the inlet end 44 to the outlet end 46. Each of the heated tubes 42 may be positioned in the interior volume 36 of the furnace housing 26 to receive heat radiated from the heating elements 40. For example, the heating elements 40 may be positioned on the opposing housing walls 34 and configured to radiate heat to provide a heat input to the heated tubes 42. In some embodiments, one or more of the heating elements 40 may be connected to one or more of the housing walls 34, suspended from an interior of an upper portion of the furnace housing 26, and/or supported within the interior volume 36 of the furnace housing 26.

As shown in FIG. 1, in some embodiments, the heating assembly 10 may include a control system 48 that includes one or more furnace controllers 48a and 48 b configured to control operation of the electrically powered furnace 12, for example, as will be understood by those skilled in the art. Although two furnace controllers are shown, the number may be greater than two in various embodiments. For example, the heating assembly 10 may include a first furnace controller 48a and a second furnace controller 48b, each configured to control operation of a respective heating zone 38a and 38b. The heating assembly 10 may further include a plurality of furnace sensor(s) 50, such as, for example, voltage sensors, current sensors, temperature sensors, pressure sensors, flow rate sensors, etc., in communication with the control system. The control system may use control logic in the form of computer software and/or hardware programs to make control decisions associated with controlling operation of the respective heating zones 38a and/or 38b, which may comprise adjusting the output of furnace controller(s) 48a and/or 48b. The control system may use various algorithms, such as algorithms based on feedback or feed-forward control logic, or combinations thereof, to maintain the exit temperature of the feed at or near a desired value, while maintaining the temperatures of the heating element surfaces within predefined parameters. The control system may make adjustments to the heating zone outputs to respond to changes in operation of the feed heating process and the furnace, for example changes in feed rate or temperature, changes in heat transfer rate (for example changes caused by coke deposition inside the heating tubes), and other changes that would affect the feed exit temperature and/or the heating element temperature distribution. Some embodiments may include a transformer upstream of the furnace controller(s) 48a and/or 48b to reduce the voltage to a level appropriate for operating the electrically powered furnace 12 as intended. In some embodiments, the power may be controlled, for example, via phase angle control, cross-over switching, or other voltage or current control schemes, as will be understood by those skilled in the art.

Maintaining the temperature of the heating elements within predetermined parameters may mean adjusting the furnace controllers such that the highest heating element temperature does not exceed a predefined maximum temperature, such as a temperature at which a rate of degradation of the heating element becomes unacceptable, or it may mean adjusting the furnace controllers such that the highest heating element temperature is maintained as low as practical, which maintaining the feed exit temperature at its desired value.

In some embodiments, the heating assembly 10 may include valves associated with the lines and/or conduits, and the furnace controller(s) 48a and/or 48b may communicate control signals based at least in part on the control decisions to control the voltage and/or current supplied to the electrically powered furnace 12, and/or to actuators associated with the valves to control the flow of the feed 14 (e.g., gases and/or liquids) and/or heat, and the actuators may be operated according to the communicated control signals to operate the electrically powered furnace 12 and/or other components of the heating assembly 10. In some examples, the furnace controller(s) 48a and/or 48b may be supplemented or replaced by human operators at least partially manually controlling the heating assembly 10 to meet desired performance parameters based at least in part on efficiency considerations and/or emissions considerations.

As shown in FIG. 1, in some embodiments, the electrically powered furnace 12 may include a first heating zone 38a including a plurality of heating elements 40 being electrically powered and configured to radiate a first heat input to a first length portion L1 of the plurality of heated tubes 42 associated with the inlet end 44 of the heated tubes 42. As shown, the electrically powered furnace 12 further may include a second heating zone 38b including a plurality of heating elements 40 being electrically powered and configured to radiate a second heat input to a second length portion L2 of the plurality of heated tubes 42 associated with the outlet end 46 of the heated tubes 42. In some embodiments, a portion of the first length portion L1 may overlap a portion of the second length portion L2, for example, where the first heat input radiates a portion of the heat onto a portion of the second length portion L2, and/or where the second heat input radiates a portion of the heat onto a portion of the first length portion L1. For example, in embodiments not having thermal insulation partitions between the first length portion L1 and the second length portion L2, it is contemplated that a portion of the first heat input will provide heat to an end of the second length portion L2 adjacent the first length portion L1, and/or a portion of the second heat input will provide heat to an end of the first length portion L1 adjacent the second length portion L2.

In some embodiments, the first heat input may be greater than an average heat input of the first heat input and the second heat input, and the second heat input may be less than the average heat input. In some embodiments, it may be possible to heat the inlet end 44 of the heated tubes 42 independently from the outlet end 46 of the heated tubes 42, for example, via the first heating zone 38a and the second heating zone 38b, respectively. Thus, the heat input at the inlet end 44 may be more closely tailored to cause the inlet end 44 to be at, or closer to, an optimal temperature to heat the feed 14 as it enters the inlet end 44 of the heated tubes 42. Similarly, the heat input at the outlet end 46 may be more closely tailored to cause the outlet end 46 to be at, or closer to, an optimal temperature to heat the feed 14 as it approaches and exits the outlet end 46 of the heated tubes 42. In some examples, this may facilitate raising the temperature of the inlet end 44 of the heated tubes 42, while not also raising the temperature of the outlet end 46 of the heated tubes 42 to a temperature higher than desired, which may result in reducing material fouling (e.g., premature coking) caused by excessive temperature of the heated tubes 42 at the outlet end 46, and which may also prevent premature wear or damage to the outlet end 46 of the heated tubes 42 caused by excessive temperature of the heated tubes 42. In some embodiments, the throughput of the electrically powered furnace 12 including two or more heating zones 38 may be increased relative to a furnace having a uniform heat input to the tubes though which a material flows and is heated. For example, by tailoring the heat input to each of the two or more heating zones, excessively high heated tube temperatures may be avoided, while providing an overall greater heat input to the heated tubes 42. As result, the material being heated may be heated more quickly without fouling or causing the heated tubes 42 to overheat. In some embodiments, by tailoring the heat input to each of the two or more heating zones, the average temperature of the plurality of heated tubes may be increased without increasing the maximum temperature of the plurality of heated tubes. In some embodiments, by tailoring the heat input to each of the two or more heating zones, the throughput may be increased by 40% (or 30%, 25%, 20%, 15%, 10%, or 5%.)

In some embodiments, the electrically powered furnace 12 may include more than two heating zones 38. For example, some embodiments may include two to four heating zones 38, two to five heating zones 38, two to six heating zones 38, or seven or more heating zones 38. For example, some embodiments may include a third heating zone 38 including one or more third heating elements 40 and configured to radiate a third heat input to a third length portion of the heated tubes 42 between the first length portion and the second length portion. Some embodiments may include a fourth heating zone 38 including one or more fourth heating elements 40 and configured to radiate a fourth heat input to a fourth length portion of the heated tubes 42 between the third length portion and the second length portion. Some embodiments may include a fifth heating zone 38 including one or more fifth heating elements 40 and configured to radiate a fifth heat input to a fifth length portion of the heated tubes 42 between the fourth length portion and the second length portion. Some embodiments may include a sixth heating zone 38 including one or more sixth heating elements 40 and configured to radiate a sixth heat input to a sixth length portion of the heated tubes 42 between the fifth length portion and the second length portion. Some embodiments may include at least seven heating zones 38, each including respective one or more heating elements 40 and configured to radiate a respective heat input to a respective length portion of the heated tubes 42 between the first length portion and the second length portion. In some embodiments, one or more of heating elements 40 may be configured to provide heat input to two or more of the heating zones 38. For example, the one or more heating elements 40 may be configured to have differing heat outputs along the length thereof to provide different heat inputs to different portions of the heated tubes 42 according to the different heating zones 38.

In some embodiments, each of the different heating zones 38 may be configured or controlled to provide different respective heat outputs, for example, such that heating zone(s) 38 between the respective inlet ends 44 of the heated tubes 42 and the respective mid-points of the lengths of the heated tubes 42 provide more heat input to the heated tubes 42 than the average heat input of the heating zones 38. In some embodiments, heating zone(s) 38 between the respective mid-points of the lengths of the heated tubes 42 and the respective outlet ends 46 of the heated tubes 42 may be configured or controlled to provide less heat input to the heated tubes 42 than the average heat input of the heating zones 38.

For example, some embodiments, of the electrically powered furnace 12 may include one or more of a first heating zone 38, a second heating zone 38, a third heating zone 38, a fourth heating zone 38, a fifth heating zone 38, a sixth heating zone 38, or at least seven heating zones 38. In some such embodiments, the heated tubes 42 may each define a heated tube length having an intermediate region or location (e.g., a midpoint), and one or more of the first heating zone 38, the third heating zone 38, the fourth heating zone 38, the fifth heating zone 38, the sixth heating zone 38, or the at least seven heating zones 38 may include one or more inlet zones positioned to radiate heat to the heated tubes 42 between the inlet end 44 and the intermediate region, each of the one or more inlet zones having a heat input ranging from 100% to 150% of an average heat input of the one or more of the first heat input, the second heat input, the third heat input, the fourth heat input, the fifth heat input, the sixth heat input, or the at least seven heat inputs. One or more of the second heating zone 38, the third heating zone 38, the fourth heating zone 38, the fifth heating zone 38, the sixth heating zone 38, or the at least seven zones 38 may include one or more outlet zones positioned to radiate heat to the heated tubes 42 between the intermediate region and the outlet end 46, each of the one or more outlet zones having a heat input ranging from 60% to 100% of an average heat input of the one or more of the first heat input, the second heat input, the third heat input, the fourth heat input, the fifth heat input, the sixth heat input, or the at least seven respective heat inputs. In some embodiments, the heat input in the first heating zone 38 may be above the average heat input, the heat input of the second heating zone 38 may be below the average heat input, and the heat input of one or more of intermediate heating zones 38 between the first heating zone 38 and the second heating zone 38 (e.g., the third through seventh heating zones) heating zones (when present) may be either (1) the average heat input or above the average heat input, or (2) the average heat input or below the average heat input.

In some embodiments, the electrically powered furnace 12 may include, in addition to a first heating zone 38 and a second heating zone 38, a third heating zone 38 including one or more third heating elements 40 and configured to radiate a third heat input to a third length portion of the heated tubes 42 between the first length portion and the second length portion, and a fourth heating zone 38 including one or more fourth heating elements 40 and configured to radiate a fourth heat input to a fourth length portion of the heated tubes 42 between the third length portion and the second length portion. In some such embodiments, the first heat input may range from 102% to 150% of the average heat input of the first heat input, the second heat input, the third heat input, and the fourth heat input. In some embodiments, the third heat input may range from 100% to 130% of the average heat input. In some embodiments, the fourth heat input may range from 70% to 100% of the average heat input. In some embodiments, the second heat input may range from 60% to 98% of the average heat input. The heat input of each heating element may vary depending on the distance between the heating element and the heated tubes, the distance between the heated tubes, and/or the distance between heated elements. The heat input may change as operating conditions change or coking of hydrocarbons in the heated tubes changes their heat transfer properties and temperature profiles over time.

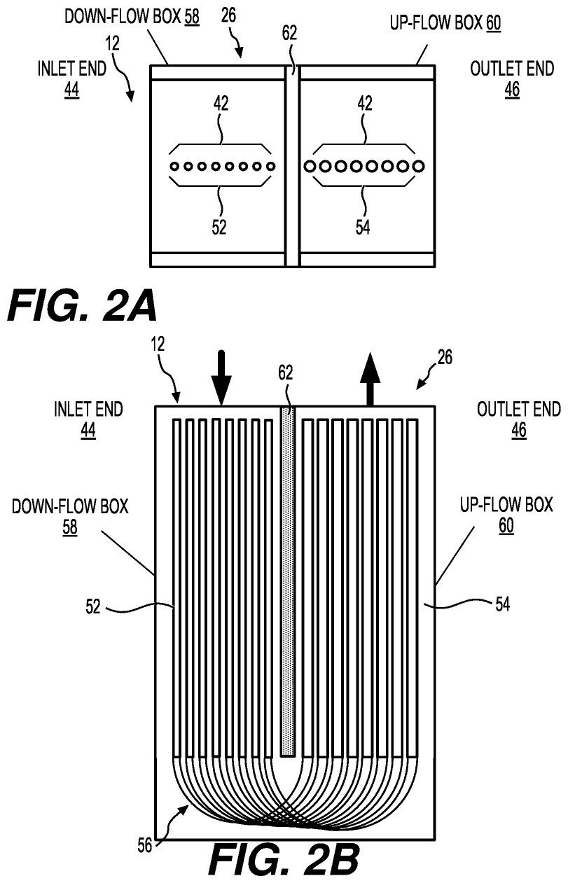

FIG. 2A schematically illustrates a top view of an example electrically powered furnace 12 according to embodiments of the disclosure, and FIG. 2B schematically illustrates a side view the example electrically powered furnace 12 shown in FIG. 2A according to embodiments of the disclosure. As shown in FIGS. 2A and 2B, in some embodiments of the electrically powered furnace 12, each of the heated tubes 42 may include a down-flow portion 52 associated with the inlet end 44, an up-flow portion 54 associated with the outlet end 46, and a bend portion 56 connecting the down-flow portion 52 and the up-flow portion 54. In some such embodiments, the furnace housing 26 may include a down-flow box 58 and an up-flow box 60 through which the down-flow portion 52 and the up-flow portion 54 extend, respectively, for example, as shown in FIGS. 2A and 2B. As shown in FIGS. 2A and 2B, the electrically powered furnace 12 further may include a thermal partition 62 between the down-flow portion 52 and the up-flow portion 54. The thermal partition 62 may be configured to at least partly thermally insulate the down-flow portion 52 from the up-flow portion 54 or act as a radiation shield between the down-flow portion and the up-flow portion, for example, to reduce or prevent heat transfer between the down-flow portion 52, the up-flow portion 54, and/or between different heating zones 38 associated with the down-flow portion 52 and/or the up-flow portion 54. The length of the thermal partition 62 may be configured based at least in part on the location of one or more of the heating zones 38. For example, the thermal partition 62 may extend at least partially across, mostly across, or fully across the height, width, and/or length of the furnace housing 26.

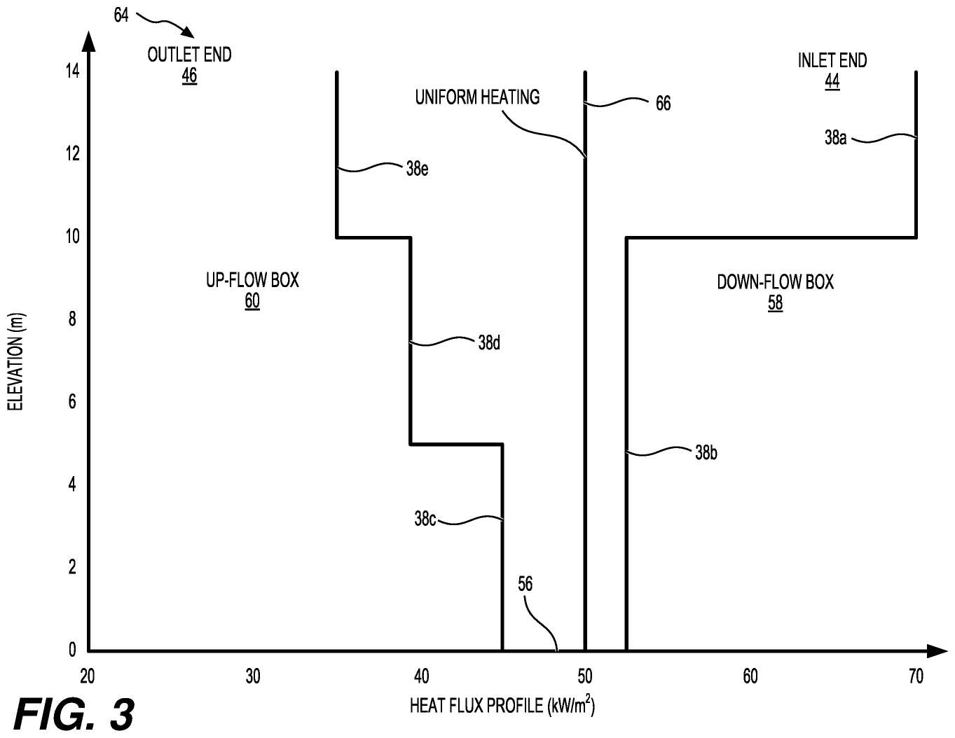

FIG. 3 is a graph 64 showing heat input as a function heated tube position for an electrically powered furnace 12 consistent with the example electrically powered furnace 12 shown in FIGS. 2A and 2B, according to embodiments of the disclosure. In the graph 64, the inlet end 44 of the electrically powered furnace 12 is at the right end of the graph 64, and the outlet end 46 of the electrically powered furnace 12 is at the left end of the graph 64. Referring to FIG. 2B, which shows the inlet end 44 on the upper left side of the electrically powered furnace 12 and the outlet end 46 on the upper right side of the electrically powered furnace 12, as depicted, the feed flows through the heated tubes 42 (see FIG. 2A) from the inlet end 44, through the down-flow portion 54, through the bend portion 56, through the up-flow portion 54, and out the outlet end 46.

As shown in the graph 64, the electrically powered furnace 12 to which the graph 64 relates includes five heating zones 38a, 38b, 38c, 38d, and 38e, each providing a respective heat flux or heat input as shown on the horizontal axis. As shown, the first heating zone 38a has a heat flux of 70 kW/m² and generally corresponds to the down-flow portion 52 from the inlet end 44 at 14 meters down to 10 meters. In some embodiments, one or more of the heating zones 38a-38e may be the same length. In some embodiments, one or more of the heating zones 38a-38e may have different lengths. Beginning at 10 meters and ending at the bend portion 56, the second heating zone 38b provides a heat flux (kW/m²) of about 52 kW/m². As the material begins to travel up the up-flow portion 54 from zero elevation to about 5 meters, the third heating zone 38c provides a heat flux of about 45 kW/m². Between about 5 meters elevation and about 10 meters, the fourth heating zone 38d provides a heat flux of about 38 kW/m². From about 10 meters elevation to the outlet end 46 at 14 meters, the fifth heating zone 38e provides a heat flux of about 35 kW/m². Thus, the graph 64 illustrates an example in which the heat flux provided by the first through fifth heating zones 38a through 38e consistently drops as the feed passes through the heated tubes 42 from the inlet end 44 to the outlet end 46. This contrasts with the line 66 showing a constant and uniform heat flux of about 50 kW/m² as the feed passes through the heated tubes 42 from the inlet end 44 to the outlet end 46. Other relative heat input strategies are contemplated, for example, depending on the desired heating of the heated tubes 42.

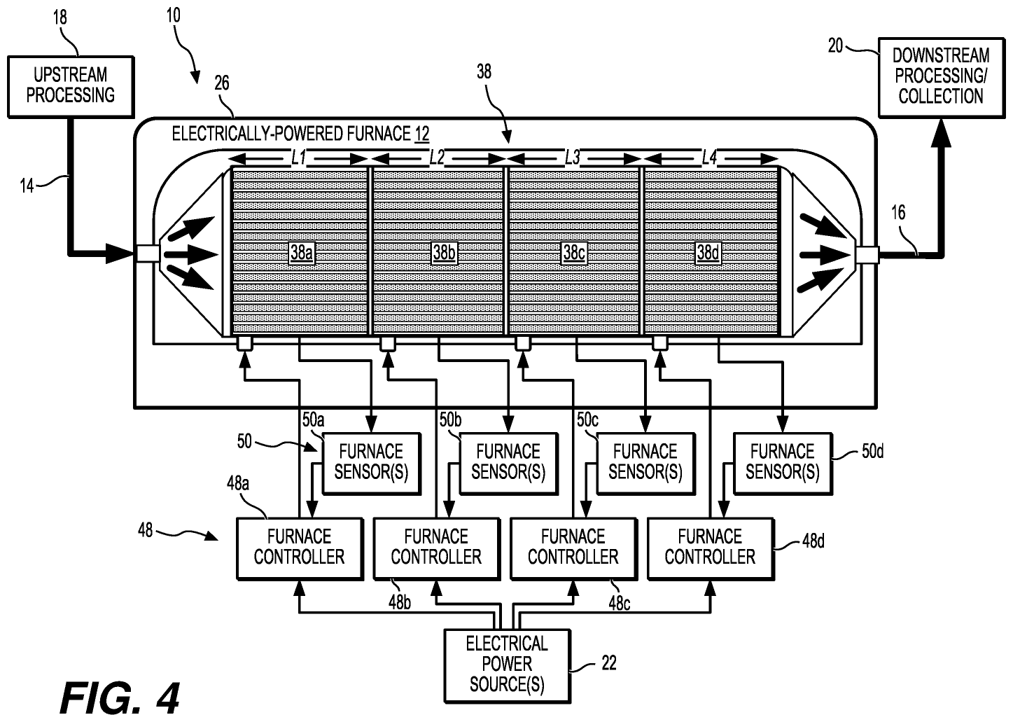

FIG. 4 schematically illustrates a side view of another example heating assembly 10 according to embodiments of the disclosure. As shown in FIG. 4, in some embodiments, the electrically powered furnace 12 may include four heating zones 38, including a first heating zone 38a, a second heating zone 38b, a third heating zone 38c, and a fourth heating zone 38d. For example, as shown, the first heating zone 38a may include one or more first heating elements that are electrically powered and configured to radiate a first heat input to a first length portion L1 of the heated tubes 42. The second heating zone 38b may include a plurality of second heating elements that are electrically powered and configured to radiate a second heat input to a second length portion L2 of the heated tubes 42. The third heating zone 38c may include a plurality of third heating elements that are electrically powered and configured to radiate a third heat input to a third length portion L3 of the heated tubes 42. The fourth heating zone 38d may include a plurality of fourth heating elements that are electrically powered and configured to radiate a fourth heat input to a fourth length portion L4 of the heated tubes 42.

In some embodiments, the first and second heat inputs may each be greater than an average heat input of the first, second, third, and fourth heat inputs, and the third and fourth heat inputs may be less than the average heat input. In some embodiments, it may be possible to heat the first, second, third, and/or fourth length portions L1, L2, L3, and/or L4 independently from one another, for example, via the first, second, third, and/or fourth heating zones 38a, 38b, 38c, and/or 38d, respectively. Thus, the heat input at the inlet end 44 may be more closely tailored to cause the inlet end 44 to be at, or closer to, an optimal temperature to heat the feed 14 as it enters the inlet end 44 of the heated tubes 42. Similarly, the heat input at the outlet end 46 may be more closely tailored to cause the outlet end 46 to be at, or closer to, an optimal temperature to heat the feed 14 as it approaches and exits the outlet end 46 of the heated tubes 42. In some examples, this may facilitate raising the temperature of the inlet end 44 of the heated tubes 42, while not also raising the temperature of the outlet end 46 of the heated tubes 42 to a temperature higher than desired, which may result in reducing material fouling (e.g., premature coking) caused by excessive temperature of the heated tubes 42 at the outlet end 46, and which may also prevent premature wear or damage to the outlet end 46 of the heated tubes 42 caused by excessive temperature of the heated tubes 42. In some embodiments, the throughput of the electrically powered furnace 12 including four or more heating zones 38 may be increased relative to a furnace having a uniform heat input to the tubes through which a material flows and is heated. For example, by tailoring the heat input by each of the four or more heating zones, excessively high heated tube temperatures may be avoided, while providing an overall greater heat input to the heated tubes 42. As result, the material being heated may be heated more quickly without fouling or causing the heated tubes 42 to overheat. In some embodiments, the respective heat inputs may be tailored such that the tube wall temperature of the heated tubes 42 remains substantially constant along the length of the heated tubes 42. In some embodiments, the heat input may decrease along the length of the electrically powered furnace 12 from an input end of electrically powered furnace 12 to an output end of the electrically powered furnace 12. For example, in the embodiment shown in FIG. 4, the first heat input may be greater than or equal to the second heat input, which may be greater than or equal to the third heat input, which may be greater than or equal to the fourth heat input.

For example, as shown in FIG. 4, some embodiments of the heating assembly 10 may include one or more furnace controllers 48 configured to control operation of the electrically powered furnace 12, for example, as will be understood by those skilled in the art. For example, the heating assembly 10 may include a first furnace controller 48a, a second furnace controller 48b, a third furnace controller 48c, and/or a fourth furnace controller 48d, each configured to control operation of a respective first through fourth heating zones 38a through 38b. The heating assembly 10 may further include a plurality of furnace sensor(s) 50 (e.g., sensor(s) 50a, 50b, 50c, and 50d), such as, for example, voltage sensors, current sensors, temperature sensors, pressure sensors, flow rate sensors, etc., in communication with one or more of the first through fourth furnace controller(s) 48a through 48d, and the one or more of the first through fourth furnace controller(s) 48a through 48d may use control logic in the form of computer software and/or hardware programs to make control decisions associated with controlling operation of the respective first through fourth heating zones 38a through 38d. In some embodiments, one of more of the first through fourth furnace controllers 48a through 48d may be combined into a single furnace controller. Some embodiments may include a transformer upstream of the furnace controllers to bring the voltage down a level appropriate for operating the electrically powered furnace 12 as intended. In some embodiments, the power may be controlled, for example, via phase angle control, cross-over switching, or other voltage control schemes, as will be understood by those skilled in the art.

In some embodiments, the heating assembly 10 may include valves associated with the lines and/or conduits, and the first through fourth furnace controllers 48a through 48d may communicate control signals based at least in part on the control decisions to control the voltage and/or current supplied to the electrically powered furnace 12, and/or to actuators associated with the valves to control the flow of the feed 14 (e.g., gases and/or liquids) and/or heat, and the actuators may be operated according to the communicated control signals to operate the electrically powered furnace 12 and/or other components of the heating assembly 10. In some examples, one or more of the first through fourth furnace controllers 48a through 48d may be supplemented or replaced by human operators at least partially manually controlling the heating assembly 10 to meet desired performance parameters based at least in part on efficiency considerations and/or emissions considerations.

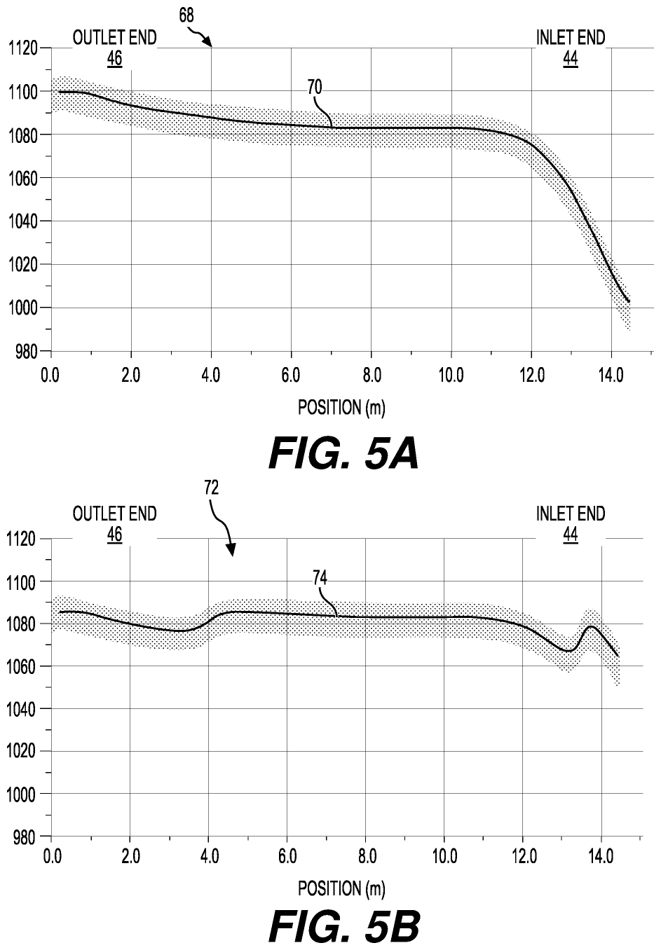

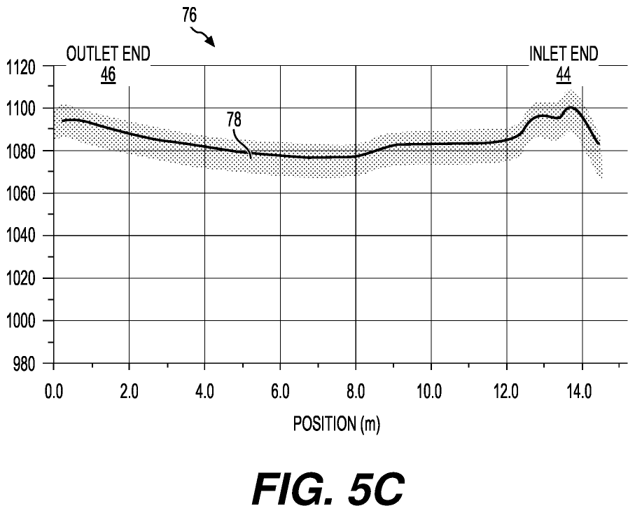

FIG. 5A is a graph 68 representative of an output of a simulation to determine the temperature 70 of an outer diameter surface of a heated tube as a function of position along the length of the heated tube for a furnace having a single heating zone with a constant heat flux across the length of the furnace wall. FIG. 5B is a graph 72 representative of an output of a simulation to determine the temperature 74 of an outer diameter surface of an example heated tube 42 as a function of position along the length of the heated tube 42 for an example electrically powered furnace 12 having three heating zones, according to embodiments of the disclosure. FIG. 5C is a graph 76 representative of an output of a simulation to determine the temperature 78 of an outer diameter surface of an example heated tube 42 as a function of position along the length of the heated tube 42 for an example electrically powered furnace 12 having six heating zones, according to embodiments of the disclosure. These simulations were performed using ANSYS Fluent three-dimensional computational fluid dynamics modeling software. Radiative, convective, and conductive heat transport as well as the thermodynamics and kinetics of ethane cracking reactions are calculated to determine the temperature at the furnace wall, the heat flux and temperature at the inner and outer diameter surfaces of the tube wall, and the temperature and conversion of the gases inside the heated tube. For the calculations in FIGS. 5A, B, and C, a rectangular furnace with two heated walls having a power input of 2.99 MJ/kg total feed (steam and ethane) was simulated; this simulation uses a heating wall model instead of resolving the heat input into individual heating elements. This furnace contained nine one-pass tubes with a length of 14.5 m and an outer diameter of 56.64 mm; 0.033 kg/s of total feed entered the tubes at approximately 690° C. and a pressure of 200 kPa; conversion to ethylene was approximately 70%.

As shown in FIG. 5A, the graph 68 of the temperature 70 of the outer diameter surface of the heated tube shows that the temperature 70 of the heated tube varies dramatically from about 1010 degrees C. at the inlet end 44 to about 1100 degrees C. at the outlet end 46. The line 70 has a width at all temperatures of the position along the heated tube length because the heated tube receives heat input from two opposing sides only, and thus, the portions of the heated tube adjacent the walls and wall heaters receive relatively more heat input than portions of the heated tube not adjacent the walls. As a result, some portions of the outer diameter surface are hotter than other portions of the outer diameter surface. FIG. 5A illustrates this phenomenon by showing the line 70 having a width corresponding to the range of temperatures of the outer diameter surface (e.g., about 10 to 15 degrees C. as shown).

As shown in FIG. 5A, because the heat input to the heated tube corresponding to FIG. 5A is uniform (e.g., along its length), the temperature of the outer surface of the heated tube varies greatly from the inlet end 44 to the outlet end 46. This results from the feed 14 entering the heated tube at a lower temperature than the temperature of the feed 14 once the feed 14 has been heated while passing through the heated tube. Upon exit, the feed 14 has been heated, thereby contributing to the temperature of the outer diameter surface, which is also being heated by the uniform heat input. As a result, for the uniform heat input depicted in FIG. 5A, the inlet end 44 has a significantly lower temperature than the outlet end 46.

In contrast with FIG. 5A, the graph 72 of FIG. 5B shows the temperature 74 of an outer diameter surface of an example heated tube 42 as a function of position along the length of the heated tube 42 for an example electrically powered furnace 12, according to embodiments of the disclosure. The example shown in FIG. 5B includes three heating zones 38, each providing a different heat input along the length of the heated tube 42, with the heat input at the inlet end 44 (e.g., at a first heating zone) being greater than an adjacent heat input (e.g., at a second heating zone), which, in turn is greater than the heat input at the outlet end 46 (e.g., at a third heating zone). Unlike the outer diameter surface temperature 70 of FIG. 5A, the outer diameter surface temperature 74 shown in FIG. 5B is substantially constant from the inlet end 44 to the outlet end 46, ranging from about 1070 degrees C. at the inlet end 44 to about 1085 degrees C. at the outlet end 46. By providing a relatively greater heat input at the inlet end 44 and a relatively lower heat input at the outlet end 46, the outer diameter surface temperature of the heated tube 42 remains substantially constant from the inlet end 44 to the outlet end 46 of the heated tube 42.

Similar to FIG. 5B, the graph 76 of FIG. 5C shows the temperature 78 of an outer diameter surface of an example heated tube 42 as a function of position along the length of the heated tube 42 for an example electrically powered furnace 12, according to embodiments of the disclosure. The example shown in FIG. 5C includes six heating zones 38, each providing a different heat input along the length of the heated tube 42, with the heat input at the inlet end 44 (e.g., at a first heating zone) being greater than an adjacent heat input (e.g., at a second heating zone), which, in turn, may be greater than the heat input of the next adjacent heating zone (e.g., at a third heating zone), which, in turn, may be greater than the heat input of the next adjacent heating zone (e.g., at a fourth heating zone), which, in turn, may be greater than the heat input of the next adjacent heating zone (e.g., at a fifth heating zone), which, in turn, may be greater than the heat input at the outlet end 46 (e.g., at a sixth heating zone). Unlike the outer diameter surface temperature 70 of FIG. 5A, the outer diameter surface temperature 78 shown in FIG. 5C is substantially constant from the inlet end 44 to the outlet end 46, being about 1,085 degrees C. at the inlet end 44 and about 1,085 degrees C. at the outlet end 46, dropping to about 1,070, degrees C. between the inlet end 44 and the outlet end 46. By providing a relatively greater heat input at the inlet end 44 and a relatively lower heat input at the outlet end 46, the outer diameter surface temperature of the heated tube 42 remains substantially constant from the inlet end 44 to the outlet end 46 of the heated tube 42

In some examples, this may facilitate raising the temperature of the inlet end 44 of the heated tubes 42, while not also raising the temperature of the outlet end 46 of the heated tubes 42 to a temperature higher than desired, which may result in reducing material fouling (e.g., premature coking) caused by excessive temperature of the heated tubes 42 at the outlet end 46, and which may also prevent premature wear or damage to the outlet end 46 of the heated tubes 42 caused by excessive temperature of the heated tubes 42. In some embodiments, the throughput of the electrically powered furnace 12 including two or more heating zones 38 may be increased relative to a furnace having a uniform heat input to the tubes though which a material flows and is heated. For example, by tailoring the heat input by each of the two or more heating zones 38, excessively high heated tube temperatures may be avoided, while providing an overall greater heat input to the heated tubes 42. As result, in some embodiments, the material being heated may be heated more quickly without fouling or causing the heated tubes 42 to overheat.

In some embodiments, the temperature of an outer surface of each of the heated tubes 42 may define a temperature profile along a length of the heated tube 42 between the inlet end 44 and the outlet end 46, and the temperature profile may remain within 85% (e.g., calculated as maximum temperature in degrees Kelvin minus the minimum temperature in degrees Kelvin divided by the maximum temperature in degrees Kelvin) of a maximum temperature of the temperature profile from the inlet end 44 to the outlet end 46 when heating the feed 14 flowing through the interior passage from the inlet end 44 to the outlet end 46. For example, the temperature profile may remain within 90% of a maximum temperature, within 92% of the maximum temperature, within 93% of the maximum temperature, within 94% of the maximum temperature, within 95% of the maximum temperature, within 96% of the maximum temperature, within 97% of the maximum temperature, within 98% of the maximum temperature, or within 99% of the maximum temperature of the temperature profile from the inlet end 44 to the outlet end 46. In some embodiments, the electrically powered furnace 12 may include or be a steam cracking furnace, and the heat input from the two or more heating zones 38 are such that the outer temperature of the outer surface of each of the heated tubes 42 ranges from a minimum temperature ranging from 850 degrees C. (e.g., at the beginning of operation and thereafter) to 1,080 degrees C. (e.g., from 1,040 degrees C. to 1,080 degrees C.) to a maximum temperature ranging from 1,000 degrees C. (e.g., at the beginning of operation and thereafter) to 1,150 degrees C. (e.g., from 1,050 degrees C. to 1,150 degrees C.) along a length of each of the heated tubes 42 from the inlet end 44 to the outlet end 46. In some embodiments, the difference between the maximum tube temperature and the average tube temperature may be less than 50 degrees C. (or 40 degrees C., or 30 degrees C., or 20 degrees C., or 10 degrees C.)

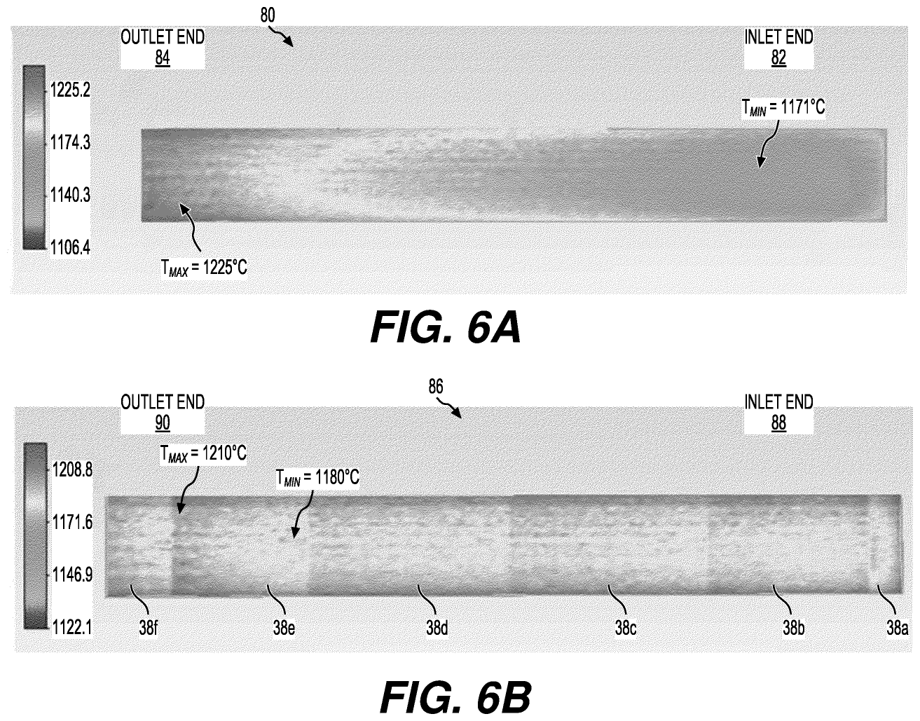

FIG. 6A illustrates a model representative of a furnace wall temperature field 80 for a furnace having a single heating zone with a constant heat flux across the length of the furnace wall from an inlet end 82 at the right-hand side of the figure as shown to an outlet end 84 at the left-hand side of the figure as shown. The calculated wall temperature field provides an estimate of the temperature distribution of the surfaces of heating elements mounted on these walls. The furnace simulations represented in FIGS. 6A and 6B were obtained by a procedure similar to that described for FIGS. 5A and 5C, although in this instance naphtha is cracked in the tubes rather than ethane, and the geometric design and process conditions are somewhat different. For the example modeled furnace wall of FIG. 6A, as shown by the modeled temperature field 80, the furnace wall has a minimum temperature T_{MIN} (about 1,171 degrees C.) at the inlet end 82 and a maximum temperature T_{MAX} (about 1,225 degrees C.) at the outlet end 84; the average wall temperature is 1,186.5 degrees C. This may result from heat radiated by the heated tubes inside the furnace. For example, the heated tubes through which the material being heated flows, radiate and/or reflect heat back toward the furnace wall. Thus, the outlet end of the heated tubes, where the material being heated in the heated tubes has the highest temperature, may generally correspond to the location of the maximum temperature of the heated tubes. Thus, the outlet end of the heated tubes radiates and/or reflects relatively more heat to the furnace wall at the outlet end of 84 of the furnace wall. As a result, the outlet end 84 of the furnace wall may be relatively hotter than the inlet end 82 of the furnace wall, which is shown by the furnace wall temperature field 80 in FIG. 6A.

In some embodiments according to the disclosure, the electrically powered furnace 12 may include multiple heating zones 38 that are controlled in a manner that may result in a relatively more constant temperature profile of the multiple heating elements 40 across the multiple heating zones 38, for example, in order to minimize the maximum temperature and/or minimize the temperature variation of the heating elements 40 from the inlet end to the outlet end of the portion of the electrically powered furnace 12 across which the multiple heating elements 40 provide heat input. In some embodiments, the heat flux may be controlled to be higher where the heated tubes 42 may tend to be cooler and/or to be lower where the heated tubes 42 may tend to be hotter. In some embodiments, the heat flux may be controlled to be higher, for example, where the heating elements 40 would otherwise tend to be cooler, and/or to be lower, for example, where the heating elements 40 may tend to be hotter. This may allow for the same total heat input with a lower heating element maximum temperature. This may result in supplying the same total heat input, or in some instances, more heat input, to the heated tubes 42 while also reducing the maximum temperature of the heating elements 40 across the length of the electrically powered furnace 12 from the inlet end to the outlet end. In some examples, the service life of the heating elements 40 may correlate (e.g., inversely) to the maximum temperature of the heating elements 40. Thus, providing multiple heating zones 38, which may be controlled to reduce the maximum temperature of the heating elements 40 while still providing as much, or more, heat input, may result in increasing the service life of the heating elements 40, for example, as compared to a furnace having a single zone heat input, as shown in FIG. 6A. In some embodiments, multiple heating zones may be provided, for example, such that the maximum heating element temperature is less than 1,350 degrees C. (or 1,300 degrees C., 1,275 degrees C., 1,250 degrees C., 1,225 degrees C., or 1200 degrees C.). In some embodiments, multiple heating zones may be provided, for example, such that the maximum heating element temperature is no more than 50 degrees C. (or 40 degrees C., 30 degrees C., 20 degrees C., 10 degrees C., or 5 degrees C.) higher than the average heating element temperature. In some embodiments, the percentage difference between the maximum and the average element temperatures (e.g., defined as the maximum temperature in degrees Kelvin minus the average temperature in degrees Kelvin divided by the average temperature in degrees Kelvin) may be reduced to less than 10% (or 8%, 6%, 5%, 4%, 3%, 2%, 1.5%, 1%, or 0.5%).

The output of the lowest output heating zone may be at least 10% below the output of a highest output heating zone.

FIG. 6B is illustrates a model representative of a furnace wall temperature field 86 for an example electrically powered furnace 12 having six heating zones 38a, 38b, 38c, 38d, 38e, and 38f distributed across the length of the furnace wall from an inlet end 88 at the right-hand end as shown to an outlet end 90 at the left-hand end as shown, according to embodiments of the disclosure, the six zones operated at 92.5%, 95%, 97.8%, 100%, 110%, and 125%, respectively, of the heat flux from the single zone in the example of FIG. 6A. The total heat output is the same in both examples. In the example shown in FIG. 6B, the maximum heating element temperature T_{MAX} is about 1,210 degrees C. and does not drop below a minimum temperature T_{MIN} of about 1,180 degrees C.; the average heating element temperature may be 1,190 degrees C. This maximum heating element temperature T_{MAX} is lower than the maximum heating element temperature T_{MAX} of about 1,225 degrees C. shown in FIG. 6A. In contrast to FIG. 6A, the multiple heating zones 38a-38f shown in FIG. 6B may be controlled in a manner that may result in a relatively constant temperature profile of multiple heating elements across the multiple heating zones 38a-38f, for example, in order to minimize the maximum temperature and/or minimize the temperature variation of the heating elements from the inlet end 88 to the outlet end 90 of the portion of the electrically powered furnace 12 across which the multiple heating elements provide heat input. In certain embodiments, the output of the lowest output heating zone is at least 5%, or 10%, or 20% below the output of the highest output heating zone. This may result in supplying the same total heat input, or in some instances, more heat input, to the heated tubes 42 while also reducing the maximum temperature of the heating elements 40 across the length of the electrically powered furnace 12 from the inlet end 88 to the outlet end 90. According to some embodiments, at least one controller may be provided to control the supply of electrical power to the heating elements 40, such that respective maximum temperatures of one or more of the heating elements 40 may be minimized. According to some embodiments, at least one controller may be provided to control the supply of electrical power to the heating elements 40, for example, such that the difference between the maximum and the average heating element temperature may be minimized.

Simulations such as the ones used to produce FIG. 5 and FIG. 6 may form the basis for constructing a predictive model, which allows estimation of the temperatures of the heating element and heating tube surfaces in the furnace that result from operation at different combinations of external process parameters (such as feed rate and temperature of the feed), equipment states (such as extent of carbon deposition in the heating tubes), and controlled variables (such as the fractional output to each of the heating zones). Such a predictive model may be used in the implementation of a control algorithm that achieves the objectives set out in this disclosure.

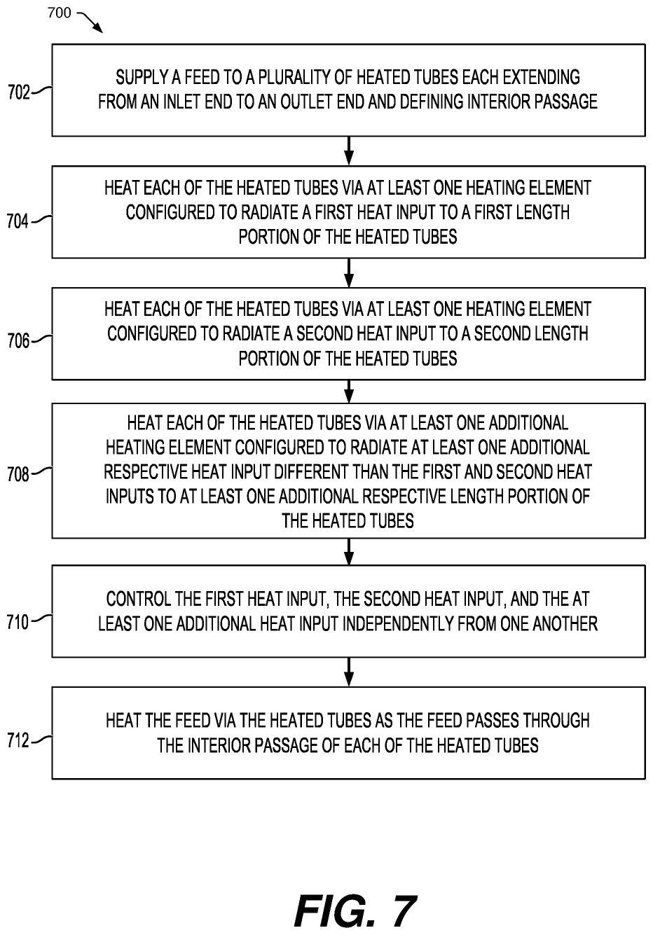

FIG. 7 is a block diagram of an example method 700 to heat a material feed, according to embodiments of the disclosure, illustrated as a collection of blocks in a logical flow scheme, which represent a sequence of operations. The order in which the operations are described is not intended to be construed as a limitation, and any number of the described blocks may be combined in any order and/or in parallel to implement the method.

FIG. 7 is a block diagram of an example method 700 to heat a material feed by passing the material feed through one or more heated tubes of an electrically powered furnace, according to embodiments of the disclosure. For example, the material feed may include, but is not limited to, hydrocarbons, and the heating of the material feed may be part of a process to crack the hydrocarbons, for example, as part of a hydrocarbon cracking process, as part of a methane reformation process, or as part of a dehydrogenation process. Other types of feeds and/or heating processes are contemplated.

The example method 700, at 702, may include supplying a feed to a plurality of heated tubes each extending from an inlet end to an outlet end and defining interior passage. For example, the plurality of heated tubes may be positioned in an interior volume of a furnace housing, for example, as described previously herein.

At 704, the example method 700 also may include heating each of the plurality of heated tubes via a first heating element configured to radiate a first heat input to a first length portion of the plurality of heated tubes associated with the inlet end. For clarity, there may be one or more heating elements in each zone, and a single heating element may stretch over multiple zones. Additionally, a heating element in a first zone may radiate heat to more than one zone. For example, the plurality of heated tubes may be positioned in the furnace housing, for example, as described previously herein. In some embodiments, the heating elements may be configured to radiate heat when activated by suppling electrical power to the heating elements. The heat radiated by the heating elements may provide heat input to the heated tubes, for example, as previously described herein.

The example method 700, at 706, further may include heating each of the plurality of heated tubes via a second heating element configured to radiate a second heat input to a second length portion of the plurality of heated tubes associated with the outlet end. For example, the first heat input may be greater than an average of the first heat input and the second heat input, and the second heat input may be less than the average heat input.

The example method 700, at 708, also may include heating each of the plurality of heated tubes via at least one additional heating element configured to radiate at least one additional respective heat input different than the first heat input and different than the second heat input to at least one additional respective length portion of the plurality of heated tubes between the first length portion and the second length portion. For example, this may be performed as previously described herein.

At 710, the example method 700 further may include controlling the first heat input, the second heat input, and the at least one additional heat input independently from one another, such that the first heat input is greater than the at least one additional respective heat input, and the at least one additional respective heat input is greater than the second heat input. In some embodiments of the example method 700, it may include controlling the supply of electricity to one or more of the heating elements such that the maximum temperature of one or more of the plurality of heating elements is minimized. In some embodiments, the example method 700 may include controlling the supply of electricity to one or more of the heating elements, for example, such that the difference between the maximum temperature of the one or more of the heating elements and the average temperature of the one or more heating elements may be minimized.

At 712, the example method 700 may include heating the feed via the plurality of heated tubes as the feed passes through the interior passage of each of the heated tubes from the inlet end to the outlet end. For example, the heat radiated by the first and second heating elements may provide heat input to the heated tubes, for example, as previously described herein. As the feed passes through the interior passage of the heated tubes, the feed may be heated.

Having now described some illustrative embodiments of the disclosure, it should be apparent to those skilled in the art that the foregoing is merely illustrative and not limiting, having been presented by way of example only. Numerous modifications and other embodiments are within the scope of one of ordinary skill in the art and are contemplated as falling within the scope of the disclosure. In particular, although many of the examples presented herein involve specific combinations of method acts or system elements, it should be understood that those acts and those elements may be combined in other ways to accomplish the same objectives. Those skilled in the art should appreciate that the parameters and configurations described herein are exemplary and that actual parameters and/or configurations will depend on the specific application in which the systems and techniques of the disclosure are used. Those skilled in the art should also recognize or be able to ascertain, using no more than routine experimentation, equivalents to the specific embodiments of the disclosure. It is, therefore, to be understood that the embodiments described herein are presented by way of example only and that, within the scope of any appended claims and equivalents thereto, the embodiments of the disclosure may be practiced other than as specifically described.

Furthermore, the scope of the present disclosure shall be construed to cover various modifications, combinations, additions, alterations, etc., above and to the above-described embodiments, which shall be considered to be within the scope of this disclosure. Accordingly, various features and characteristics as discussed herein may be selectively interchanged and applied to other illustrated and non-illustrated embodiment, and numerous variations, modifications, and additions further can be made thereto without departing from the spirit and scope of the present disclosure as set forth in the appended claims.

What is claimed is:

1. A method of heating a feed, wherein the method comprises:
providing an electrically powered furnace having an output of at least one megawatt and comprising:
a control system;
a furnace housing comprising one or more housing walls at least partially defining an interior volume;
a plurality of heating zones within the interior volume, each of the plurality of heating zones comprising one or more heating elements being electrically powered and radiating heat from their surfaces when activated, wherein each of the plurality of heating zones responds independently to the control system, wherein the control system varies an output of the one or more heating elements in each zone as a fraction of a maximum output of each of the one or more heating elements;
a plurality of heated tubes extending in the interior volume, each of the plurality of heated tubes extending between an inlet end and an outlet end and defining an interior passage positioned to receive the feed and heat the feed as the feed passes through the interior passage from the inlet end to the outlet end, and the plurality of heated tubes being positioned in the furnace housing to receive heat radiated from the one or more heating elements in each of the plurality of heating zones;
providing the feed to the electrically powered furnace; and
algorithmically adjusting the output of the one or more heating elements for each of the plurality of heating zones to heat the feed to a desired temperature while maintaining temperatures of the one or more heating elements within predetermined parameters.

2. The method according to claim 1, wherein temperatures of the one or more heating elements are instrumentally measured during operation, and the measured temperatures are used in algorithmically adjusting the output of the one or more heating elements for each of the plurality of heating zones.

3. The method according to claim 1, wherein temperatures of the one or more heating elements are calculated from a prediction model, and the calculated temperatures are used in algorithmically adjusting the output of the one or more heating elements for each of the plurality of heating zones.

4. The method according to claim 1, wherein algorithmically adjusting the output of the one or more heating elements comprises minimizing a highest temperature among combined heating element surfaces.

5. The method according to claim 1, wherein the control system utilizes a ratio of outputs from each of the plurality of heating zones to maintain an even temperature distribution across the one or more heating elements while maintaining process performance.

6. The method according to claim 1, wherein the predetermined parameters are uniformity of temperature, wherein the maximum difference between the highest temperature on any heating element surface and the lowest temperature on any heating element surface is smaller than 100 degrees Celsius, preferably less than 60, more preferably less than 30, during standard operation of the furnace.

7. The method according to claim 1, wherein the control system determines a relative power output to each of the plurality of heating zones.

8. The method according to claim 1, wherein one or more heating zones near the inlet end of the plurality of heating tubes have a higher output than one or more heating zones near the outlet end of the plurality of heating tubes.

9. The method according to claim 8, wherein the output of the lowest output heating zone is at least 10% below the output of a highest output heating zone.

10. The method according to claim 1, wherein the electrically powered furnace further comprises a thermal partition between a) a first subset of the plurality of heating zones and a first portion of the plurality of heated tubes, and b) a second subset of the plurality of heating zones and a second portion of the plurality of heated tubes, wherein the thermal partition at least partially thermally insulates the first subset and first portion from the second subset and second portion.

11. The method according to claim 1, wherein the number of heating zones is greater than two.

12. The method according to claim 1, wherein the one or more heating elements are electrically resistive elements attached or adjacent to a housing wall.

13. The method according to claim 1, wherein the furnace housing further comprises a conductive refractory that radiates heat to the plurality of heated tubes when activated.

14. An apparatus operating the feed heating method according to claim 1.
